(19) United States
(12) Patent Application Publication
(10) Pub. No.: US 2022/0391779 A1
(43) Pub. Date: Dec. 8, 2022

(54) SYSTEMS AND METHODS FOR REWARD-DRIVEN FEDERATED LEARNING

(71) Applicant: JPMORGAN CHASE BANK, N.A., New York, NY (US)

(72) Inventors: Sudhir UPADHYAY, Edison, NJ (US); Monik Raj BEHERA, Wilmington, DE (US)

(21) Appl. No.: 17/804,859

(22) Filed: Jun. 1, 2022

(30) Foreign Application Priority Data
Jun. 2, 2021 (IN) 202111024627

(51) Int. Cl. G06N 20/20; G06Q 20/14

(52) U.S. Cl. CPC G06N 20/20; G06Q 20/145

(57) ABSTRACT

Systems and methods for federated learning based on a reward-driven approach are disclosed. In one embodiment, a method may include: (1) receiving, by a federated contribution computer program executed by a federated node in a distributed ledger network, a plurality of local machine learning model updates from a plurality of clients in the distributed ledger networks; (2) retrieving, by the federated contribution computer program, a prior global machine learning model; (3) calculating, by the federated contribution computer program, a current global machine learning model based on the prior global machine learning model and the plurality of local machine learning model updates; (4) determining, by the federated contribution computer program, a federated contribution for each client based on each client's federated contribution to the current global machine learning model; and (5) issuing, by the federated contribution computer program, rewards to each client based on the client's federated contribution.

### RELATED APPLICATIONS

This application claims priority to, and the benefit of, Indian Patent Application Number 202111024627, filed Jun. 2, 2021, the disclosure of which is hereby incorporated, by reference, in its entirety.

### BACKGROUND OF THE INVENTION

### 1. Field of the Invention

Embodiments generally relate to systems and methods for reward-driven federated learning.

### 2. Description of the Related Art

Federated machine learning continues to gain interest and momentum where there is a need to draw insights from data, while preserving the privacy of the data provider. Among the existing challenges in the adoption of federated learning is the lack of fair, transparent and universally agreed incentivization schemes for rewarding the model contributors.

Unless distributed ledgers, such as blockchain-based distributed ledgers, implement a privacy layer, all communications between any two nodes are visible to the other nodes in the network. Preserving the privacy of transaction in a blockchain, while still allowing all nodes to participate in consensus process, is a difficult problem to solve.

This poses a challenge for federated learning that requires maintaining privacy of the individual models (and model gradients) as well as the anonymity of the model contributor. Current solutions address this challenge by dynamically generating asymmetric and symmetric keys for each federated learning round, with a caveat that the aggregation server node is a “consortium”—trusted infrastructure. Even with consortium-trusted aggregation server implementation, there is still a risk of a lack of contribution in the overall federated learning from individual nodes. In addition, malicious nodes could potentially send a misleading model that could skew the efficacy of the aggregated models. Current solutions address this by having an aggregation server detect such behavior and drop those contributors from the collaboration process.

Further, in addition to the existing challenges in federated learning, current solutions lack a transparent and incentive-driven contribution from model collaboration.

### SUMMARY OF THE INVENTION

Systems and methods for federated learning based on a reward-driven approach are disclosed. In one embodiment, a method for reward-driven federated learning may include: (1) receiving, by a federated contribution computer program executed by a federated node in a distributed ledger network, a plurality of local machine learning model updates from a plurality of clients in the distributed ledger networks; (2) retrieving, by the federated contribution computer program, a prior global machine learning model; (3) calculating, by the federated contribution computer program, a current global machine learning model based on the prior global machine learning model and the plurality of local machine learning model updates; (4) determining, by the federated contribution computer program, a federated contribution for each client based on each client's contribution to the current global machine learning model; and (5) issuing, by the federated contribution computer program, rewards to each client based on the client's federated contribution.

In one embodiment, the federated contribution may include a scalar quantity that represents a deviation or divergence of the prior global machine learning model and the current global machine learning model.

In one embodiment, the rewards may include a payment or a fee.

In one embodiment, the method may also include refusing, by the federated contribution computer program, a local machine learning model update from a client with a low federated contribution.

In one embodiment, each of the plurality of local machine learning model updates may include a plurality of weights for the local machine learning models, the local machine learning models, etc.

According to another embodiment, a method for reward-driven federated learning may include: (1) receiving, by a federated contribution computer program executed by a federated node in a distributed ledger network, a plurality of local machine learning model updates from a plurality of clients in the distributed ledger networks; (2) retrieving, by the federated contribution computer program, a prior global machine learning model; (3) calculating, by the federated contribution computer program, a current global machine learning model based on the prior global machine learning model and the plurality of local machine learning model updates; (4) determining, by the federated contribution computer program, a federated contribution for each client based on each client's contribution to the current global machine learning model; (5) calculating, by the federated contribution computer program, a relative federated contribution for each of the clients, and the rewards are issued based on the client's relative federated contribution; and (6) issuing, by the federated contribution computer program, rewards to each client based on the client's relative federated contribution.

In one embodiment, wherein the federated contribution may include a scalar quantity that represents a deviation or divergence of the prior global machine learning model and the current global machine learning model.

In one embodiment, the rewards may include a payment or a fee.

In one embodiment, the method may also include refusing, by the federated contribution computer program, a local machine learning model update from a client with a low relative federated contribution.

In one embodiment, each of the plurality of local machine learning model updates may include a plurality of weights for the local machine learning models, the local machine learning models, etc.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for reward-driven federated learning according to one embodiment; and

FIG. 2 depicts a method for reward-driven federated learning according to one embodiment.

### DETAILED DESCRIPTION OF PREFERRED EMBODIMENTS

Embodiments are directed to systems and methods for federated learning based on a reward driven approach.

Embodiments may leverage a unique and transparent smart contract design on a distributed ledger to reward honest/active participants, and penalize malicious/underperforming participants, in the learning process based on computing a novel, scalar quantity, referred to as a “federated contribution.” In embodiments, a smart contract may be responsible for rewarding or penalizing specification and distribution (or fees) via immutable federated contribution records written to the distributed ledger.

In one embodiment, a computer program executed at an aggregator node may compute the federated contribution based on the latest trained model weights, which will be pushed from individual nodes to the aggregator node in a distributed ledger network.

The disclosure of Behera et al., “Federated Learning using Smart Contracts on Blockchains, based on Reward Driven Approach,” arXiv:2107.10243 (2021), is hereby incorporated, by reference, in its entirety.

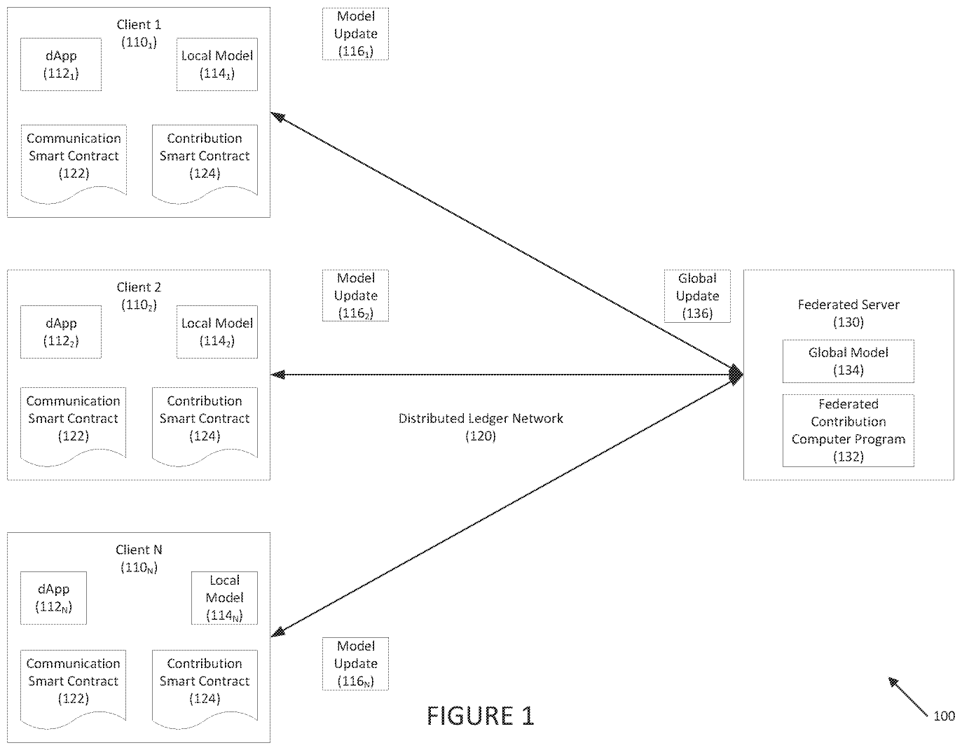

Referring to FIG. 1, a system for reward-driven federated learning is disclosed according to an embodiment. System 100 may include a plurality of clients 110 (e.g., client 1101, client 1102, . . . client 110N). Each client 110 may participate as a node in distributed ledger network 120, such as a blockchain-based distributed ledger network.

Each client 110 may execute a distributed application, or “dApp” 112 (e.g., dApp 112₁, dApp 112₂, . . . dApp 112_{N}) that may train and maintain a local model (e.g., local model 114₁, local model 114₂, . . . local model 114_{N}). dApps 112 may also send model updates 116 (e.g., model update 116₁, model update 116₂, . . . model update 116_{N}) for local models 114 to federated contribution computer program 132, listen for events published by federated contribution computer program 132, and may update local models 114 with global update 136.

In one embodiment, model updates 116 may be encrypted.

Federated server 130 may execute federated contribution computer program 132. Federated server 130 may perform aggregated machine learning on global model 134 using model updates 116. Examples of such aggregated machine learning training are disclosed in Indian Patent Application Number 202211021939, filed Apr. 12, 2022, Indian Patent Application No. 202111004346, filed Feb. 1, 2021, U.S. patent application Ser. No. 17/649,471, filed Jan. 31, 2022, Indian Patent Application No. 202111042412, filed Sep. 20, 2021, U.S. patent application Ser. No. 17/654,450, filed Mar. 11, 2022, Indian Patent Application No. 202011050561, filed Nov. 20, 2020, and U.S. patent application Ser. No. 17/456,113, filed Nov. 22, 2021. The disclosure of each of these documents are hereby incorporated, by reference, in their entirety.

Federated server 130 may communicate global update 136 to clients 110. Global update 136 may include updates to model weights, the model, etc. for clients 110 to use to update their respective local models 114. Federated server 130 may also generate events for clients 110, such as requests for model updates 116. Thus, federated server 130 may orchestrate communications in distributed ledger network 120.

Communication smart contract 122 and contribution smart contract 124 may be hosted on executed by clients 110 within distributed ledger network 120. Communication smart contract 122 may facilitate the transfer of model updates 116 and global update 136. Contribution smart contract 124 may record the contribution of each client 110 transparently on distributed ledger network 120.

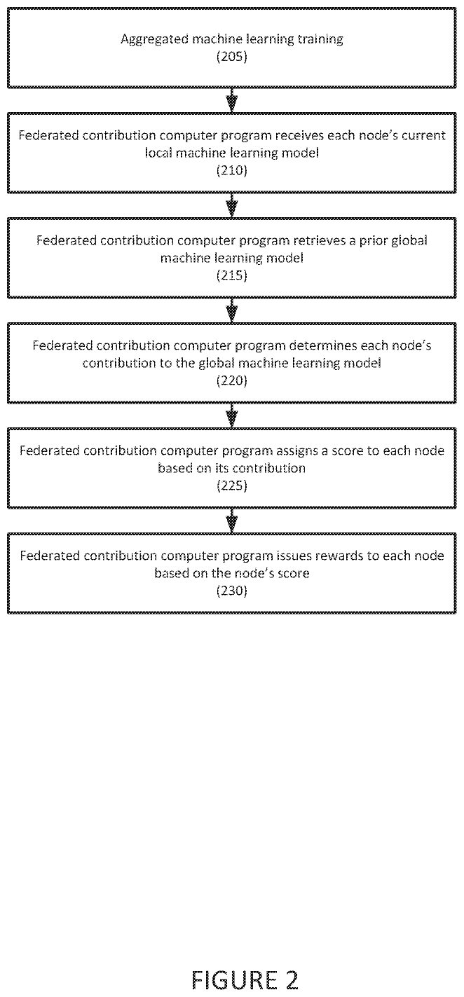

Referring to FIG. 2, a method for reward-driven federated learning is disclosed according to an embodiment.

In step 205, clients and a federated server in a distributed ledger network may perform aggregated machine learning training on local models. For example, computer programs, such as dApps, executed by the clients may train local machine learning models and may provide updates to their local models to a federated learning computer program executed by the federated server node.

In step 210, the federated contribution computer program may receive the updates to each client node's current local model. For example, each dApp executed by each client may provide a model update from its local model to the federated learning computer program. The model updates may include weights, the local models themselves, etc.

In step 215, the federated contribution computer program may retrieve a prior aggregated machine learning model from the federated server, from the distributed ledger, etc. For example, the federated server or distributed ledger may store the prior global model and may use it and the updates from the clients to train a global machine learning model. The federated contribution computer program may provide updates based on the global machine learning model to the clients after completion of one federated learning cycle.

In step 220, the federated contribution computer program may determine each client's contribution to the global machine learning model. The federated contribution may be a scalar quantity that depicts the deviation or divergence of two machine learning models based on each client's contribution. The federated contribution (γ^{k}) for each client k may be defined as follows:

$${γ}^{b} := {‖ {β}^{k} ‖}_{2}$$

$${β}^{k} := 〈 {‖ {δ}_{1}^{k} ‖}_{F} , {‖ {δ}_{2}^{k} ‖}_{F} , … , {‖ {δ}_{L}^{k} ‖}_{F} 〉$$

$${δ}_{l}^{k} := {w}_{l , t}^{global} - {w}_{l , t + 1}^{k}$$

$${γ}_{rel}^{k} := \frac{{γ}^{k}}{{\sum }_{k = 1}^{K} {γ}^{k}}$$

where:
   |.|₂ represents the Frobenius norm, which may represent a magnitude of deviation between two weight matrices (e.g., the global weight matrix of previous iteration and local weight matrix of current iteration, for layer l);
L represents the weight matrix of the final layer (e.g., the last layer before the output layer in the neural network) of a generic machine learning model (the architecture is the same at local clients and at the federated server);
δ^{k}ₗ represents a difference of a model weight parameter matrix for the l^{th} layer of the k^{th} client;
w_{kl;t+1} represents the model weight for l^{th} layer of k^{th} client at t+1^{th} iteration;
w_{globall,t} is the model weight for l^{th} layer of global model at t^{th} iteration;
γ^{k}ᵣₑₗ is relative federated contribution of client k.

For example, each client's federated contribution γ^{k} may be inferred by calculating δ^{k}ₗ and then calculating β^{k} according to the equations above. If the federated contribution value γ^{k} is relatively high, that means the given client has contributed to a higher degree. Describing the federated contribution to a higher or a lower degree practically quantifies each client's contribution in modifying the global model by training on larger data points, or by training over data points that are have distant statistical properties from earlier training data or may have higher noise in data. The federated contribution may intuitively be thought of as the divergence of a local model after training on new data points will be greater if higher gradient descent updates are performed. This can be because of variance in new data, unseen data points, or a greater training size, etc.

Each client's relative federated contribution γ^{k}ᵣₑₗ may then be calculated to determine each client's federated contribution relative to the other clients.

In step 225, based on each client's federated contribution value γ^{k} or its relative federated contribution value γ^{k}ᵣₑₗ, the federated contribution computer program may assign a score to each node, and in step 230, the computer program may issue rewards, or penalties, to each node based on its score. For example, the rewards may be directly proportional to on-chain native currencies, based on sound economic models, etc. As an illustration, a client with a low federated contribution or relative federated contribution may receive fewer rewards, payments, etc. than a client that is making a greater federated contribution. The client making the lesser federated contribution may be required to pay to receive the global model updates.

As another example, the federated contribution computer program may disconnect a client that is not contributing to the global model, or may not take that client's model updates into account when determining the global model. The federated contribution computer program may also refuse a client's model update if the client has a low federated contribution. Any other suitable action may be taken as is necessary and/or desired.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for reward-driven federated learning, comprising:
receiving, by a federated contribution computer program executed by a federated node in a distributed ledger network, a plurality of local machine learning model updates from a plurality of clients in the distributed ledger networks;
retrieving, by the federated contribution computer program, a prior global machine learning model;
calculating, by the federated contribution computer program, a current global machine learning model based on the prior global machine learning model and the plurality of local machine learning model updates;
determining, by the federated contribution computer program, a federated contribution for each client based on each client's contribution to the current global machine learning model; and
issuing, by the federated contribution computer program, rewards to each client based on the client's federated contribution.

2. The method of claim 1, wherein the federated contribution comprises a scalar quantity that represents a deviation or divergence of the prior global machine learning model and the current global machine learning model.

3. The method of claim 1, wherein the rewards comprise a payment.

4. The method of claim 1, wherein the rewards comprise a fee.

5. The method of claim 1, further comprising:
refusing, by the federated contribution computer program, a local machine learning model update from a client with a low federated contribution.

6. The method of claim 1, wherein each of the plurality of local machine learning model updates comprise a plurality of weights for the local machine learning models.

7. The method of claim 1, wherein each of the plurality of local machine learning model updates comprise the local machine learning models.

8. A method for reward-driven federated learning, comprising:
receiving, by a federated contribution computer program executed by a federated node in a distributed ledger network, a plurality of local machine learning model updates from a plurality of clients in the distributed ledger networks;
retrieving, by the federated contribution computer program, a prior global machine learning model;
calculating, by the federated contribution computer program, a current global machine learning model based on the prior global machine learning model and the plurality of local machine learning model updates;
determining, by the federated contribution computer program, a federated contribution for each client based on each client's contribution to the current global machine learning model;
calculating, by the federated contribution computer program, a relative federated contribution for each of the clients, and the rewards are issued based on the client's relative federated contribution; and
issuing, by the federated contribution computer program, rewards to each client based on the client's relative federated contribution.

9. The method of claim 8, wherein the federated contribution comprises a scalar quantity that represents a deviation or divergence of the prior global machine learning model and the current global machine learning model.

10. The method of claim 8, wherein the rewards comprise a payment.

11. The method of claim 8, wherein the rewards comprise a fee.

12. The method of claim 8, further comprising refusing, by the federated contribution computer program, a local machine learning model update from a client with a low relative federated contribution.

13. The method of claim 8, wherein each of the plurality of local machine learning model updates comprise a plurality of weights for the local machine learning models.

14. The method of claim 8, wherein each of the plurality of local machine learning model updates comprise the local machine learning models.
